(19) United States
(12) Patent Application Publication
(10) Pub. No.: US 2026/0277906 A1
(43) Pub. Date: Sep. 17, 2026

(54) SKIPLIST-BASED DATA READ-WRITE METHOD, SYSTEM, DEVICE, AND STORAGE MEDIUM

(71) Applicant: CLOUD INTELLIGENCE ASSETS HOLDING (SINGAPORE) PRIVATE LIMITED, Singapore (SG)

(72) Inventor: Shuqi ZHAO, Beijing (CN)

(21) Appl. No.: 19/479,705

(22) PCT Filed: Jun. 17, 2024
(86) PCT No.: PCT/CN2024/099648

§ 371 Date: Oct. 28, 2025

(30) Foreign Application Priority Data
Jun. 25, 2023 (CN) 202310755146.6

(51) Int. Cl. G06F 16/2453; G06F 16/28

(52) U.S. Cl. CPC G06F 16/24549; G06F 16/284

(57) ABSTRACT

One or more embodiments of this specification provide a skiplist-based data read-write method, a system, a device, and a storage medium. The method includes: obtaining a target key of an element to be read and written; determining a next node to which the first node points at a highest index layer is a node to be compared, and cyclically performing the following process until a preset condition is satisfied: comparing a second feature value of the target key with a first feature value of the node to be compared; determining a node to be compared in a next cyclic process based on a magnitude relationship indicated by a comparison result; and performing, if the preset condition is satisfied, a read-write operation on the element to be read and written based on a node to be compared in the last cyclic process.

The present disclosure is a National Stage of the International Application No. PCT/CN2024/099648, filed on Jun. 17, 2024, which claims priority to Chinese Patent Application No. 202310755146.6, filed with the China National Intellectual Property Administration on Jun. 25, 2023 and entitled “SKIPLIST-BASED DATA READ-WRITE METHOD, SYSTEM, DEVICE, AND STORAGE MEDIUM”, and these applications are incorporated herein by reference their entireties.

### TECHNICAL FIELD

One or more embodiments in this specification relate to the field of data read-write technologies, and in particular, to a skiplist-based data read-write method, a storage system, an electronic device, and a computer-readable storage medium.

### BACKGROUND

A skiplist is a probabilistic data structure, and is essentially a sorted linked list which supports a binary search. The skiplist adds multi-level indexes to an original sorted linked list, and a quick search is achieved by using the indexes. The skiplist can not only improve search performance, but also improve performance of insertion and deletion operations. In a process of adding, deleting, searching, and modifying data, an inevitable step is to compare a key (that is, a key in a Key-Value (key-value pair) storage manner) of a tuple to be added, deleted, searched, and modified with a key stored by a node of the skiplist, to locate a position of addition, deletion, search, and modification.

For example, in a process of searching, a key of an element to be searched needs to be compared with the key in the node of the skiplist, to locate a node to be searched, so that specific content of the element to be searched is read by using a key of the node to be searched as the index. However, in a case that the key is long, running resource overheads required for a comparison operation are high.

### SUMMARY

In view of this, one or more embodiments of this specification provide a skiplist-based data read-write method, a storage system, an electronic device, and a computer-readable storage medium.

To achieve the foregoing objective, technical solutions provided in the one or more embodiments of this specification are as follows:

According to a first aspect of one or more embodiments of this specification, a skiplist-based data read-write method is provided. The skiplist includes a plurality of index layers, a node in the skiplist is used for storing a key and a first feature value, and the first feature value is used for recording a bifurcation position of a key of a current node relative to a key of a predecessor node, as well as at least some values of the key of the current node after the bifurcation position; and the method includes:
obtaining a target key of an element to be read and written;
determining, if the target key is different from a key of a first node of the skiplist, that a next node to which the first node points at a highest index layer is a node to be compared, and cyclically performing the following process until a preset condition is satisfied:
comparing a second feature value of the target key with a first feature value of the node to be compared, where the second feature value is used for recording a bifurcation position of the target key relative to a key of a predecessor node of the node to be compared, as well as at least some values of the target key after the bifurcation position;
determining, if the second feature value of the target key is different from the first feature value of the node to be compared, a node to be compared in a next cyclic process based on a magnitude relationship indicated by a comparison result; and
performing, if the preset condition is satisfied, a read-write operation on the element to be read and written based on a node to be compared in the last cyclic process.

According to a second aspect of one or more embodiments of this specification, a storage system is provided, including a data read-write apparatus and a skiplist, where the skiplist includes a plurality of index layers, a node in the skiplist is used for storing a key and a first feature value of a current node relative to a predecessor node, and the first feature value is used for recording bifurcation position information of a key of the current node and a key of the predecessor node, as well as at least some values after a bifurcation position; and
the data read-write apparatus is configured to perform the method according to any one of the first aspect.

According to a third aspect of embodiments of the present disclosure, an electronic device is provided, including:
a processor; and
a memory configured to store processor-executable instructions, where
the processor is configured to implement the method according to the first aspect when executing the executable instructions.

According to a fourth aspect of embodiments of the present disclosure, a computer-readable storage medium storing a computer program thereon is provided. The program, when executed by a processor, implements steps of the method according to any one of the foregoing.

The technical solutions provided in the embodiments of the present disclosure may include the following beneficial effects:
in the embodiments of the present disclosure, by obtaining a first feature value of a node in a skiplist and a second feature value of a target key, and comparing the second feature value of the target key with a first feature value of a node to be compared, a repeated comparison process of a common part is omitted, thereby effectively reducing comparison overheads, and optimizing read-write performance.

It should be understood that the foregoing general descriptions and the following detailed descriptions are merely exemplary and explanatory and are not intended to limit the present disclosure.

### BRIEF DESCRIPTION OF DRAWINGS

FIG. 1 is a schematic diagram of a sorted linked list and feature values provided by an exemplary embodiment.

FIG. 2 is a schematic diagram of a skiplist and first feature values provided by an exemplary embodiment.

FIG. 3 is a schematic diagram of a skiplist-based data read-write method provided by an exemplary embodiment.

FIG. 4 is a schematic diagram of a first feature value of a compound key provided by an exemplary embodiment.

FIG. 5 is a schematic diagram of a first feature value of another compound key provided by an exemplary embodiment.

FIG. 6 is a schematic diagram of a storage system provided by an exemplary embodiment.

FIG. 7 is a schematic structural diagram of a device provided by an exemplary embodiment.

### DESCRIPTION OF EMBODIMENTS

Exemplary embodiments are described in detail herein, and examples of the exemplary embodiments are shown in the accompanying drawings. When the following descriptions involve the accompanying drawings, unless otherwise indicated, the same numbers in different accompanying drawings represent the same or similar elements. Implementations described in the following exemplary embodiments do not represent all implementations that are consistent with one or more embodiments of this specification. On the contrary, they are merely examples of an apparatus and a method that are consistent with some aspects of one or more embodiments of this specification described in detail in the appended claims.

It should be noted that, in other embodiments, steps of a corresponding method are not necessarily performed in an order shown and described in this specification. In some other embodiments, the method may include more or fewer steps than those described in this specification. In addition, a single step described in this specification may be decomposed into a plurality of steps for description in other embodiments; and a plurality of steps described in this specification may be combined into a single step for description in other embodiments.

A database is a warehouse that organizes, stores, and manages data based on a data structure. The database is a collection of massive data stored in a computer for a long time, organized, shareable, and uniformly managed.

Key-value pair storage, namely, Key-Value storage, KV storage for short, is a manner of NoSQL (Not Only SQL, non-relational database) storage. Its data is organized, indexed, and stored in a form of a key-value pair. The key-value pair storage is very suitable for data storage that does not involve excessive data relationships, and has better read-write performance than database storage.

Storage space for database storage and key-value pair storage is generally large, and therefore, storage needs to be performed based on a specific design; otherwise, efficiency of performing search, deletion, and insertion operations on data is low. One of the data structures configured for storing data is a LSM-Tree (Log Structured Merge Tree). The LSM-Tree is a layered, sorted, disk-oriented data structure. A core idea is to convert all random write into sequential write to improve write performance. A main procedure thereof is that all write requests are first additionally written into a log file (WAL file), and then inserted into Mem Table in an internal memory. When the internal memory reaches a specific limit, data files are sequentially written into a disk to form an internally sorted disk file. When reading data, a multi-way merging manner is adopted to read respectively from an internal memory file and a disk file.

WAL refers to a write ahead log, is a common means in a KV storage/database system, and is configured for ensuring atomicity and persistence of a data operation. Generally, disk I/O operations are a major bottleneck in KV storage/database efficiency. Under a same data volume, when a transaction is committed, using the WAL log can reduce an I/O data volume, and convert random write into sequential write, thereby improving system performance.

A Mem Table (internal memory table) is a storage structure of content of a WAL file in the internal memory, is usually implemented by using a skiplist, and provides an operation interface for writing, deleting, and reading key-value pair data.

A skiplist is a probabilistic data structure, and is essentially a sorted linked list which supports a binary search. The skiplist adds multi-level indexes to an original sorted linked list, and a quick search is achieved by using the indexes. The skiplist can not only improve search performance, but also improve performance of insertion and deletion operations. In a process of adding, deleting, searching, and modifying data, an inevitable step is to compare a key (that is, a key in a Key-Value (key-value pair) storage manner) of a tuple to be added, deleted, searched, and modified with a key stored by a node of the skiplist, to locate a position of addition, deletion, search, and modification.

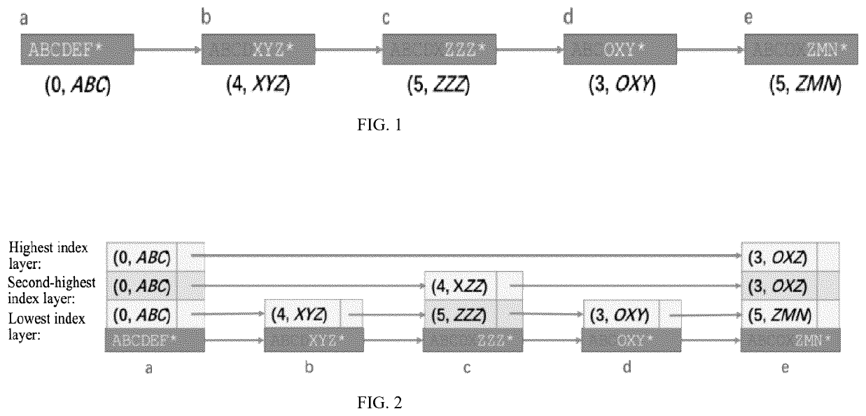

For example, in a process of searching, a key of an element to be searched needs to be compared with the key in the node of the skiplist, to locate a node to be searched, so that specific content of the element to be searched is read by using a key of the node to be searched as the index. However, in a case that the key is long, running resource overheads needed by a comparison operation are large. For example, referring to a sorted linked list (a single-level index as an example is used for description) shown in FIG. 1, the sorted list includes five nodes: {a, b, c, d, e}. It is assumed that keys are stored in the linked list (a grey part in FIG. 1), and a data type of the keys is a character string type. If it is to locate whether a node whose character string is equal to a character string S to be searched exists in the linked list, a method in the related art is to perform full character string comparison one by one, until a node whose character string is greater than or equal to the character string S is located. In a case that the character string is long, the comparison operation has a relatively high overhead.

For problems in the related art, a concept of a feature value is introduced in the embodiments of this specification, and the comparison overhead is reduced through feature value comparison. The feature value is described herein by using an example. Referring to FIG. 1, the inventor considers that the sorted linked list has some common prefixes. To reduce repeated and inefficient operations, an end position of a common prefix of each node and a predecessor node is additionally recorded. In addition, to use the internal memory more effectively, at least part of node-specific data of each node after it bifurcates from the predecessor node is further recorded.

Please refer to FIG. 1, (1) node a has no predecessor node, and a subscript of a preset bifurcation position is 0, forming a feature value (0, ABC); (2) the predecessor node of node b is node a, and a common prefix is ABCD, forming a feature value (4, XYZ); (3) the predecessor node of node c is node b, and a common prefix is ABCDX, forming a feature value (5, ZZZ); (4) the predecessor node of node d is node c, and a common prefix is ABC, forming a feature value (3, OXY); and (5) the predecessor node of node e is node d, and a common prefix is ABCOX, forming a feature value (5, ZMN).

For problems in the related art, the embodiments of this specification implement the generation of the first feature value of each node relative to the predecessor node in a process of creating the skiplist, and record it in the nodes of the skiplist. The skiplist includes a plurality of index layers, a node in the skiplist is used for storing a key and a first feature value, and the first feature value is used for recording a bifurcation position of a key of a current node relative to a key of a predecessor node, as well as at least some values of the key of the current node after the bifurcation position. Where, the bifurcation position refers to a position at which a value of the key of the current node starts to differ from a value of the key of the predecessor node.

For example, please refer to the skiplist shown in FIG. 2, a data type of a key stored in a node is the character string type, and each node includes at least one first feature value. Exemplarily, a quantity of first feature values of each node is equal to a quantity of index layers corresponding to the node. In other words, each node in the skiplist other than the first node corresponds to N index layers, thus the node has N predecessor nodes and correspondingly has N first feature values, where Nis an integer greater than 0. Where, the first node in the skiplist has no predecessor node, and a bifurcation position can be assumed to be 0.

Please refer to FIG. 2, it is assumed that a length of a common prefix of the node relative to the predecessor node and three characters after bifurcation are recorded, and there are the following conditions:
(1) node a has no predecessor node, a subscript of a preset bifurcation position is 0, corresponding to a highest, a second-highest, and a lowest index layer, thus there are three first feature values, all of which are (0, ABC).
(2) node b corresponds to the lowest index layer. A predecessor node at the lowest index layer is a, and a common prefix of the node a and the node b is ABCD, forming a first feature value (4, XYZ).
(3) node c corresponds to the second-highest and lowest index layers. A predecessor node at the second-highest index layer is a, and a common prefix of the node a and the node c is ABCD, forming a first feature value (4, XZZ); and a predecessor node at the lowest index layer is b, and a common prefix of the node b and the node c is ABCDX, forming a first feature value (5, ZZZ).
(4) node d corresponds to the lowest index layer. A predecessor node at the lowest index layer is c, a common prefix of the node d and the node c is ABC, forming a first feature value (3, OXY).
(5) node e corresponds to the highest, second-highest, and lowest index layers. A predecessor node at the highest index layer is a, and a common prefix of the node e and the node a is ABC, forming a first feature value (3, OXZ); a predecessor node at the second-highest index layer is c, and a common prefix of the node e and the node c is ABC, forming a first feature value (3, OXZ); and a predecessor node at the lowest index layer is d, and a common prefix of the node e and the node d is ABCOX, forming a first feature value (5, ZMN).

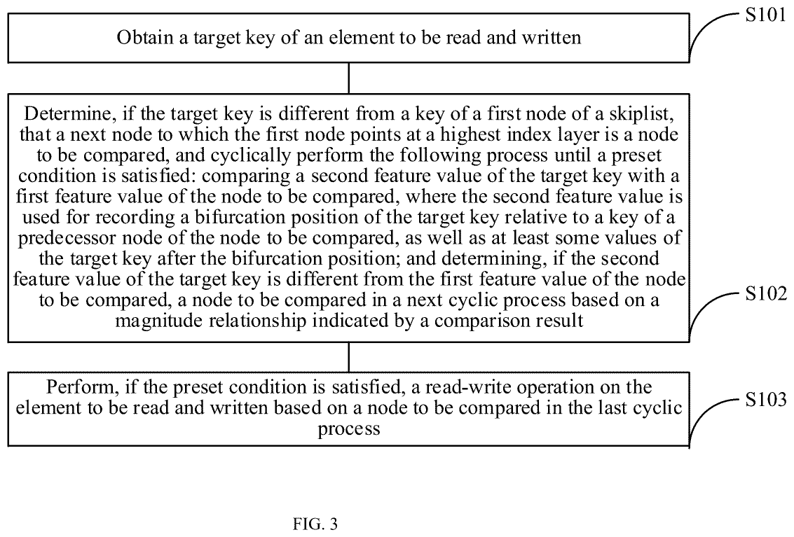

For problems in the related art, please refer to FIG. 3, an embodiment of this specification provides a skiplist-based data read-write method. The method may be performed by a data read-write apparatus, and the method includes the following steps.

S101: obtain a target key of an element to be read and written.

S102: determine, if the target key is different from a key of a first node of the skiplist, that a next node to which the first node points at a highest index layer is a node to be compared, and cyclically perform the following process until a preset condition is satisfied: comparing a second feature value of the target key with a first feature value of the node to be compared, where the second feature value is used for recording a bifurcation position of the target key relative to a key of a predecessor node of the node to be compared, as well as at least some values of the target key after the bifurcation position; and determining, if the second feature value of the target key is different from the first feature value of the node to be compared, a node to be compared in a next cyclic process based on a magnitude relationship indicated by a comparison result.

S103: perform, if the preset condition is satisfied, a read-write operation on the element to be read and written based on a node to be compared in the last cyclic process.

In this embodiment, a comparison process between the target key of the element to be read and written and the key of the node in the skiplist is converted into a comparison process between the second feature value of the target key and the first feature value of the node to be compared, which eliminates a repeated comparison process of a common part, thereby effectively saving comparison overheads, and achieving performance optimization.

In some embodiments, the element to be read and written includes an element to be read and an element to be written.

If the element to be read and written is the element to be read, the preset condition includes: the target key is the same as a key of the node to be compared. In a case that the preset condition is satisfied, the node to be compared in the last cyclic process may be determined as a read node corresponding to the target key in the skiplist, and a key in the read node is used as an index to read specific content of the element to be read from a corresponding storage position. In a possible case, if it is determined that keys of all nodes in the skiplist are different from the target key of the element to be read, prompt information indicating that content of the element to be read is not stored may be outputted.

If the element to be read and written is the element to be written, there are two cases. One case is to modify content of a stored element, and the other case is to write a new element.

In the first case, the preset condition includes: the target key is the same as a key of the node to be compared. In a case that the preset condition is satisfied, the node to be compared in the last cyclic process may be determined as a write node corresponding to the target key in the skiplist, and a key in the write node is used as an index to modify specific content of the element to be written at a corresponding storage position.

In the second case, the preset condition includes: there is no next node to be compared; that is, a magnitude relationship between keys of all nodes in the skiplist and a key of the element to be written has been determined through a comparison process, and no further comparison needs to be performed. Therefore, in a case that the preset condition is satisfied, an insertion position of a node corresponding to the element to be written may be determined based on the node to be compared in the last cyclic process, to implement a write operation on the element to be written. For example, it is assumed that the skiplist is sorted in ascending order., if the node to be compared in the last cyclic process is greater than a target key of the element to be written, a previous position of the node to be compared in the last cyclic process is determined as the insertion position; or if the node to be compared in the last cyclic process is less than a target key of the element to be written, a next position of the node to be compared in the last cyclic process is determined as the insertion position.

In some embodiments, if the target key is the same as the key of the first node of the skiplist, the subsequent comparison process does not need to be performed. If the element to be read and written is the element to be read, the key of the first node is used as an index to read specific content of the element to be read from a corresponding storage position. If the element to be read and written is the element to be written and is in the foregoing first case, the key of the first node is used as an index to modify specific content of the element to be written at a corresponding storage position.

In some embodiments, nodes in the skiplist may be sorted by key in ascending order or in descending order. Different sorting relationships leads to different comparison results.

If the nodes in the skiplist are sorted by key in ascending order, in a case that the target key is greater than the key of the first node of the skiplist, it is determined that the next node to which the first node points at the highest index layer is the node to be compared, and the following process is cyclically performed until the preset condition is satisfied: comparing the second feature value of the target key with the first feature value of the node to be compared, where the second feature value is used for recording the bifurcation position of the target key relative to the key of the predecessor node of the node to be compared, as well as at least some values of the target key after the bifurcation position; and determining, if the comparison result indicates that the target key is less than the key of the node to be compared, a next node to which the predecessor node of the node to be compared points at a next index layer as the node to be compared in the next cyclic process; determining, if the comparison result indicates that the target key is greater than the key of the node to be compared, a next node to which the node to be compared points at a current index layer as the node to be compared in the next cyclic process.

If the nodes in the skiplist are sorted by key in descending order, in a case that the target key is less than the key of the first node of the skiplist, it is determined that the next node to which the first node points at the highest index layer is the node to be compared, and the following process is cyclically performed until the preset condition is satisfied: comparing the second feature value of the target key with the first feature value of the node to be compared, where the second feature value is used for recording the bifurcation position of the target key relative to the key of the predecessor node of the node to be compared, as well as at least some values of the target key after the bifurcation position; and determining, if the comparison result indicates that the target key is greater than the key of the node to be compared, a next node to which the predecessor node of the node to be compared points at a next index layer as the node to be compared in the next cyclic process; or determining, if the comparison result indicates that the target key is less than the key of the node to be compared, a next node to which the node to be compared points at a current index layer as the node to be compared in the next cyclic process.

In some embodiments, a data type of a key stored by any node in the skiplist may be the character string type. Please refer to FIG. 2, a first feature value of any node includes: a first length of a common prefix between a key of the node and a key of a predecessor node, and at least some characters of the key of the node after the common prefix. The second feature value of the target key includes: a second length of a common prefix between the target key and the key of the predecessor node of the node to be compared, and at least some characters of the target key after the common prefix.

It may be understood that, quantities of at least some characters after the common prefix in the first feature value and the second feature value may be specifically set according to an actual application scenario. For example, the first feature value in FIG. 2 includes three characters, which may alternatively be two characters, four characters, or all remaining characters, of the key of the node relative to the key of the predecessor node after the common prefix. This is not limited in this embodiment. A comparison process of magnitude of character strings is carried out character by character according to ASCII code values corresponding to characters. For example, for a character string ABC and a character string ACD, first, the first characters are the same, and a second character B is less than a second character C. Therefore, the character string ABC is less than the character string ACD.

Due to a multi-level index characteristic of the skiplist, any node other than the first node corresponds to at least one index layer, and thus the any node has at least one predecessor node; and any node other than the first node corresponds to N index layers, thus the any node has N predecessor nodes and correspondingly has N first feature values, where N is an integer greater than 0.

Next, the comparison process is exemplarily described by using an example in which the nodes in the skiplist are sorted by key in ascending order.

First, the target key is compared with the key of the first node of the skiplist. If the target key is the same as the key of the first node of the skiplist, a matching node is determined, the following operations do not need to be performed, and the following read-write operation is performed based on the matching node; or if the target key is different from the key of the first node of the skiplist, specifically, (1) if the target key is less than the key of the first node of the skiplist, it indicates that the target key does not exist in the skiplist; for the element to be written and the case in which a new element is to be written, the insertion position may be determined before the first node, to implement the write operation on the element to be written; and for other cases, if the target key does not exist in the skiplist, error reporting information may be outputted.

(2) if the target key is greater than the key of the first node of the skiplist, comparison needs to be continued, a second feature value of the target key relative to the first node is generated, where the second feature value is used for recording a bifurcation position of the target key relative to the key of the first node as well as at least some values of the target key after the bifurcation position, the next node to which the first node points at the highest index layer is determined as the node to be compared, and the following process is cyclically performed until the preset condition is satisfied: comparing the second feature value of the target key with the first feature value of the node to be compared; and determining, if the second feature value of the target key is different from the first feature value of the node to be compared, a node to be compared in a next cyclic process based on a magnitude relationship indicated by a comparison result.

It may be understood that, the second feature value of the target key and the first feature value of the node to be compared, which are involved in the comparison, are generated relative to a same predecessor node. In a first case, if the second length being greater than the first length indicates that the target key is less than the key of the node to be compared, the next node to which the predecessor node of the node to be compared points at the next index layer is determined as the node to be compared in the next cyclic process.

In a second case, if the second length being less than the first length indicates that the target key is greater than the key of the node to be compared, a second feature value of the target key relative to the node to be compared is generated, and the next node to which the node to be compared points at the current index layer is determined as the node to be compared in the next cyclic process.

In a third case, if the second length being equal to the first length and characters in the second feature value being less than characters in the first feature value indicate that the target key is less than the key of the node to be compared, the next node to which the predecessor node of the node to be compared points at the next index layer is determined as the node to be compared in the next cyclic process.

In a fourth case, if the second length being equal to the first length and characters in the second feature value being greater than characters in the first feature value indicate that the target key is greater than the key of the node to be compared, a second feature value of the target key relative to the node to be compared is generated, and the next node to which the node to be compared points at the current index layer is determined as the node to be compared in the next cyclic process.

For example, please refer to FIG. 2, it is assumed that a target key S (which is assumed to be ******) exists. To reduce comparison steps, in a case that there is no predecessor node, it is assumed that a bifurcation position is 0, then a feature value (0, ***) of the target key S may be first generated and compared with a first feature value (0, ABC) of a head node a at a highest index layer, and a second feature value, assumed to be (α, β), of the target key S relative to the head node a is generated.

If the target key S is less than the head node a, the target key S does not exist in the skiplist, and searching is exited. For example, it is assumed that the target key S is ABADAB and the head node has no predecessor node, and it is assumed that the bifurcation position is 0, then a feature value (0, ABA) of the target key S may be first generated and compared with the first feature value (0, ABC) of the head node a at the highest index layer. ABA is less than ABC, thus the target key S is less than the head node a.

If the target key S is greater than the head node a, a next node e to which the head node a points at the highest index layer is determined as the node to be compared. For example, it is assumed that the target key S is ABDDAB and the head node has no predecessor node, and it is assumed that the bifurcation position is 0, then a feature value (0, ABD) of the target key S may be first generated and compared with the first feature value (0, ABC) of the head node a at the highest index layer. ABD is greater than ABC, thus the target key S is greater than the head node a.

There are the following several cases in which the second feature value (assumed to be (α, β)) of the target key S is compared with a first feature value (3, OXZ) of the node e to be compared at the highest index layer.
(1) α>3, indicating that the target key S and the node a have a longer common prefix, the node e is greater than the target key S, and there is no need to compare content. A next node to be compared is a next node c to which the node a points at the second-highest index layer. For example, it is assumed that the target key S is ABCDABC, then the second feature value (α, β) of the target key S relative to the head node a is (4, ABC); a first length of the node e to be compared being 3 represents that a character “O” at the fourth position of the node e is greater than a character “D” at the fourth position of the node a, while a first length of the target key being 4 represents that a character “D” at the fourth position of the target key S is the same as the character “D” at the fourth position of the node a, then apparently, the character “O” at the fourth position of the node e is greater than the character “D” at the fourth position of the target key S, and the node e is greater than the target key S.
(2) α<3, indicating that the target key S and the node a have a shorter common prefix, the target key S being greater than the node a indicates that the target key S is also greater than the node e, a second feature value of the target key S relative to the node e is generated, and a next node to be compared is a next node to which the node e points at the highest index layer. For example, it is assumed that the target key S is ABXXABC, then the second feature value (α, β) of the target key S relative to the head node a is (2, XXA); the first length of the node e to be compared being 3 represents that a character at the third position of the node e is the same as a character at the third position of the node a, while the first length of the target key being 2 represents that a character at the third position of the target key S is greater than the character at the third position of the node a, then apparently, the character at the third position of the target key S is greater than the character at the third position of the node e, that is, the target key S is greater than the node e.
(3) α=3, indicating that bifurcation positions are the same, and then the following character comparison process is performed. If B in the target key S is less than OXZ in the node e, it indicates that the target key S is less than the node e, and a next node to be compared is a next node c to which the node a points at the second-highest index layer.
(4) α=3, indicating that bifurcation positions are the same, and then the following character comparison process is performed. If B in the target key S is greater than OXZ in the node e, it indicates that the target key S is greater than the node e, a second feature value of the target key S relative to the node e is generated, and a next node to be compared is a next node to which the node e points at the highest index layer.

In a possible implementation, if characters in the first feature value and characters in the second feature value are not all remaining characters after the common prefix, and the second feature value is the same as the first feature value, remaining characters of the target key after the common prefix may be compared with remaining characters of the node to be compared after the common prefix.

For example, it is assumed that there are a key A (ABCDEF), a key B (ABCEDFJE), and a key C (ABCEDFGF); relative to the key A, a common prefix of the key B is ABC, and three characters after the bifurcation position are stored, that is, (3, EDF); relative to the key A, a common prefix of the key C is ABC, and three characters after the bifurcation position are stored, that is, (3, EDF); the common prefixes are the same, and the stored three characters are also the same, however, the stored characters are not all remaining characters after the bifurcation position. Therefore, comparison between the last remaining parts is also comparison between the “JE” in the key B and the “GF” in the key C.

In a first case, if the former is greater than the latter, the second feature value of the target key relative to the node to be compared is generated, and the next node to which the node to be compared points at the current index layer is determined as the node to be compared in the next cyclic process.

In a second case, if the former is less than the latter, the next node to which the predecessor node of the node to be compared points at the next index layer is determined as the node to be compared in the next cyclic process.

In a third case, if the remaining value in the target key is equal to the remaining value in the key of the node to be compared, which represents that the target key is the same as the key of the node to be compared, the cycle ends.

The foregoing example continues to be used. Please refer to FIG. 2, in a process in which the second feature value (assumed to be (α, β)) of the target key S is compared with the first feature value (3, OXZ) of the node e to be compared at the highest index layer, if the second feature value of the target key S is the same as the first feature value of the node e to be compared at the highest index layer, that is, the bifurcation positions are the same, and some characters after the bifurcation position are also the same, the remaining characters after the bifurcation position are compared, that is, character string content after the sixth character of the target key S and character string content after the sixth character of the node e are compared. If the target key S is greater than the node e, the second feature value of the target key S relative to the node e is generated, and the next node to be compared is the next node to which the node e points at the highest index layer. If the target key S is less than the node e, the next node to be compared is the next node c to which the node a points at the second-highest index layer.

A person skilled in the art may understand that, an exemplary description is provided above by using an example in which the nodes in the skiplist are sorted by key in ascending order. Sorting of the nodes in the skiplist by key in descending order is also applicable to this solution, and details are not described herein again.

In this embodiment, for the data type of the key being the character string type, the foregoing first feature value and second feature value are generated and compared with each other, thereby avoiding a comparison process of the common prefix, reducing comparison overheads, and also improving comparison efficiency.

In some other embodiments, a key stored by any node in the skiplist is a compound key, the compound key is a key composed of two or more attributes that uniquely identify any record in a table, and data types of different keys in the compound key may be the character string type or an integer type.

The first feature value and the second feature value corresponding to a compound key form are exemplarily described herein:

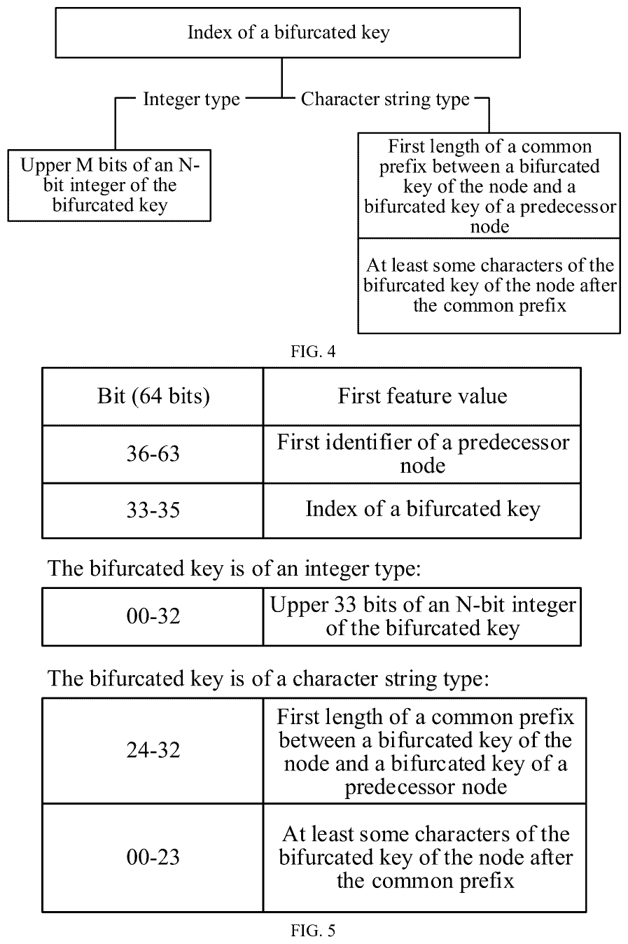

please refer to a data structure of the first feature value shown in FIG. 4, the first feature value includes an index of a bifurcated key. If a data type of the bifurcated key is the character string type, the first feature value further includes a first length of a common prefix between a bifurcated key of the node and a bifurcated key of a predecessor node, as well as at least some characters of the bifurcated key of the node after the common prefix relative to the bifurcated key of the predecessor node. If the data type of the bifurcated key is the integer type and a quantity of bits is N, the first feature value further includes upper M bits of an N-bit integer of the bifurcated key of the node, where MEN.

In other words, if the data type of the bifurcated key is the character string type, bifurcation position information in the first feature value includes the index of the bifurcated key and the first length; if the data type of the bifurcated key is the integer type, bifurcation position information in the first feature value includes the index of the bifurcated key.

Similarly, the second feature value includes an index of a bifurcated key between the target key and the predecessor node of the node to be compared. If a data type of the bifurcated key is the character string type, the second feature value further includes a second length of a common prefix between a bifurcated key of the target key and a bifurcated key of the predecessor node of the node to be compared, as well as at least some characters of the bifurcated key of the target key after the common prefix relative to the bifurcated key of the predecessor node of the node to be compared. If a data type of the bifurcated key is the integer type and a quantity of bits is N, the second feature value further includes upper M bits of an N-bit integer of the bifurcated key of the target key, where MEN.

In other words, if the data type of the bifurcated key is the character string type, bifurcation position information in the second feature value includes the index of the bifurcated key and the second length; if the data type of the bifurcated key is the integer type, bifurcation position information in the second feature value includes the index of the bifurcated key.

For example, for Table 1 below, the compound key may include a grade, a class, and a name, where data types of the grade and the class are the integer types, and a data type of the name is the character string type.

TABLE 1

| Grade | Class | Name | Score |
|---|---|---|---|
| 1 | 3 | Zhang San | 95 |
| 2 | 4 | Li Si | 80 |
| 3 | 3 | Zhang San | 88 |
| 4 | 2 | Wang Wu | 65 |
| 5 | 1 | Li Si | 78 |

For example, data types of indexes of different keys in the compound key may be integer types. For example, in ascending order of the different keys in the compound key from left to right, an index of the first key may be set to 0, an index of the second key may be set to 1, an index of the third key may be set to 2, an index of the fourth key may be set to 3, and so on. Following the foregoing example continues, an index of the first key “Grade” is 0, an index of the second key “Class” is 1, and an index of the third key “Name” is 2.

For example, data types of indexes of different keys in the compound key may also be character types. For example, in ascending order of the different keys in the compound key from left to right, an index of the first key is set to a, an index of the second key is set to b, an index of the third key is set to c, an index of the fourth key is set to d, and so on.

Where, if the data type of the bifurcated key is the integer type and is a signed integer, the signed integer further needs to be first converted into an unsigned integer, and then upper M bits are taken, to avoid impact caused by the sign and ensure accuracy of the comparison result.

For example, it is assumed that a value of M is 33. If the data type of the bifurcated key is the integer type and is the signed integer, preprocessing needs to be performed. If the bifurcated key is a 64-bit signed integer, 0x8000000000000000 is first added to the 64-bit signed integer and converted into a comparable 64-bit unsigned positive integer; if the bifurcated key is a 32-bit or lower-bit signed integer, 0x80000000 is first added to the 32-bit or lower-bit signed integer and converted into a comparable 32-bit unsigned positive integer. After the conversion into the unsigned positive integer, upper 33 bits are taken, and lower bits are discarded. If the data type of the bifurcated key is the integer type and is the unsigned integer, and if the bifurcated key is an unsigned integer within 32 bits, an original value is directly used; otherwise, upper 33 bits are taken, and lower bits are discarded.

Next, the comparison process is exemplarily described by using an example in which the nodes in the skiplist are sorted by key in ascending order and indexes of different keys in the compound key are sorted in ascending order of index values of the different keys in the compound key from left to right.

First, the target key is compared with the key of the first node of the skiplist. If the target key is greater than the key of the first node of the skiplist, the second feature value of the target key relative to the first node is generated, where the second feature value includes an index of a bifurcated key of the target key relative to the first node, the next node to which the first node points at the highest index layer is determined as the node to be compared, and the following process is cyclically performed until the preset condition is satisfied: comparing the second feature value of the target key with the first feature value of the node to be compared; and determining, if the second feature value of the target key is different from the first feature value of the node to be compared, a node to be compared in a next cyclic process based on a magnitude relationship indicated by a comparison result.

In a first case, if the index in the second feature value being greater than an index in the first feature value indicates that the target key is less than the key of the node to be compared, the next node to which the predecessor node of the node to be compared points at the next index layer is determined as the node to be compared in the next cyclic process.

In a second case, if the index in the second feature value being less than an index in the first feature value indicates that the target key is greater than the key of the node to be compared, a second feature value of the target key relative to the node to be compared is generated, and the next node to which the node to be compared points at the current index layer is determined as the node to be compared in the next cyclic process.

In a third case, if the index in the second feature value being equal to an index in the first feature value indicates that the target key is the same as a bifurcated key of the node to be compared, the node to be compared in the next cyclic process is determined based on a magnitude relationship between the target key and the key of the node to be compared indicated by remaining content of the second feature value and remaining content of the first feature value.

In a possible implementation, if the data type of the bifurcated key is the integer type, the second feature value of the target key further includes upper M bits of an N-bit integer of the bifurcated key, where M is less than and equal to N. The first feature value of the node to be compared further includes: the upper M bits of the N-bit integer of the bifurcated key, where MEN.

In a first case, if an integer in the second feature value being less than an integer in the first feature value indicates that the target key is less than the key of the node to be compared, the next node to which the predecessor node of the node to be compared points at the next index layer is determined as the node to be compared in the next cyclic process.

In a second case, if the integer in the second feature value being greater than the integer in the first feature value indicates that the target key is greater than the key of the node to be compared, the second feature value of the target key relative to the node to be compared is generated, and the next node to which the node to be compared points at the current index layer is determined as the node to be compared in the next cyclic process.

In a third case, if the integer in the second feature value is equal to the integer in the first feature value, remaining content in the target key continues to be compared with remaining content in the node to be compared.

In another possible implementation, if the data type of the bifurcated key is the character string type, the first feature value of the node to be compared further includes a first length of a common prefix between a bifurcated key of the node and a bifurcated key of the predecessor node, and at least some characters of the bifurcated key of the node after the common prefix; and the second feature value of the target key further includes a second length of a common prefix between a bifurcated key of the target key and a bifurcated key of the predecessor node of the node to be compared, and at least some characters of the bifurcated key of the target key after the common prefix.

In a first case, if the second length being greater than the first length indicates that the target key is less than the key of the node to be compared, the next node to which the predecessor node of the node to be compared points at the next index layer is determined as the node to be compared in the next cyclic process.

In a second case, if the second length being less than the first length indicates that the target key is greater than the key of the node to be compared, the second feature value of the target key relative to the node to be compared is generated, and the next node to which the node to be compared points at the current index layer is determined as the node to be compared in the next cyclic process.

In a third case, if the second length being equal to the first length and characters in the second feature value being less than characters in the first feature value indicate that the target key is less than the key of the node to be compared, the next node to which the predecessor node of the node to be compared points at the next index layer is determined as the node to be compared in the next cyclic process.

In a fourth case, if the second length being equal to the first length and characters in the second feature value being greater than characters in the first feature value indicate that the target key is greater than the key of the node to be compared, the second feature value of the target key relative to the node to be compared is generated, and the next node to which the node to be compared points at the current index layer is determined as the node to be compared in the next cyclic process.

For the bifurcated key whose the data type is the character string type, reference may be made to a description process that the data type of the key is the character string type for a related comparison process, and details are not described herein again.

A person skilled in the art may understand that, an exemplary description is provided above by using an example in which the nodes in the skiplist are sorted by key in ascending order. Sorting of the nodes in the skiplist by key in descending order is also applicable to this solution, and details are not described herein again.

In this embodiment, for the compound key, the foregoing first feature value and second feature value are generated and compared, so that comparison of same keys is skipped, and comparison is started from the bifurcated key, thereby reducing comparison overheads and also improving comparison efficiency.

In some embodiments, it is considered that in a dynamic insertion/deletion scenario, it is possible that when a query is performed, a node M is inserted between adjacent nodes X and Y. If a path search of X→M→Y is used, and when the node Y is compared, a feature value of a key to be queried relative to Mis used. However, a first feature value of the node Y relative to the node X may still be recorded in the current node Y, which has not been updated. A mismatched comparison may cause an incorrect comparison result. Therefore, please refer to FIG. 5, the first feature value further includes a first identifier of the predecessor node. The second feature value further includes a second identifier of the predecessor node of the node to be compared. In a process of comparing the second feature value of the target key with the first feature value of the node to be compared, first, a first identifier in the first feature value of the node to be compared is compared with a second identifier in the second feature value of the target key. If the first identifier in the first feature value of the node to be compared is the same as the second identifier in the second feature value of the target key, it represents that the predecessor node of the node to be compared is the same as the predecessor node of the target key, and other content in the second feature value of the target key may continue to be compared with other content of the first feature value of the node to be compared. For a related comparison process, reference may be made to the foregoing descriptions, and details are not described herein again.

If the first identifier in the first feature value of the node to be compared is different from the second identifier in the second feature value of the target key, the target key is compared with a key of the node to be compared, that is, all content of the target key is compared with all content of the key of the node to be compared, to avoid that a mismatched comparison may cause an incorrect comparison result, and ensure accuracy of comparison.

It may be understood that, a quantity of bits of the first feature value and a quantity of bits of the second feature value are not limited in this embodiment, and may be specifically set according to an actual application scenario. In an example, the quantity of bits of the first feature value and the quantity of bits of the second feature value may be 64. In another example, the quantity of bits of the first feature value and the quantity of bits of the second feature value may be 128. This is not limited in the embodiments of this specification.

For example, with reference to FIG. 5, an example in which the quantity of bits of the first feature value is 64 is used for description. FIG. 5 shows quantities of bits of different parts of the first feature value. For example, a quantity of bits of a first identifier of the predecessor node may be 28, and the index of the bifurcated key may be 3 bits. If the bifurcated key is of the integer type, M in FIG. 5 is 33 bits; if the bifurcated key is of the character string type, the first length is 9 bits, and a quantity of bits of characters after the common prefix is 24.

In some embodiments, a node in the skiplist is used for storing a key, a pointer to a next node, and a first feature value, where the first feature value and the pointer may be stored in a same cacheline, thereby reducing a cache miss probability in the comparison process. The various technical features in the foregoing implementations may be arbitrarily combined, as long as there is no conflict or contradiction in combinations of the features. However, for brevity only, the features are not described one by one. Therefore, any combination of the various technical features in the foregoing implementations also falls within the scope disclosed in this specification.

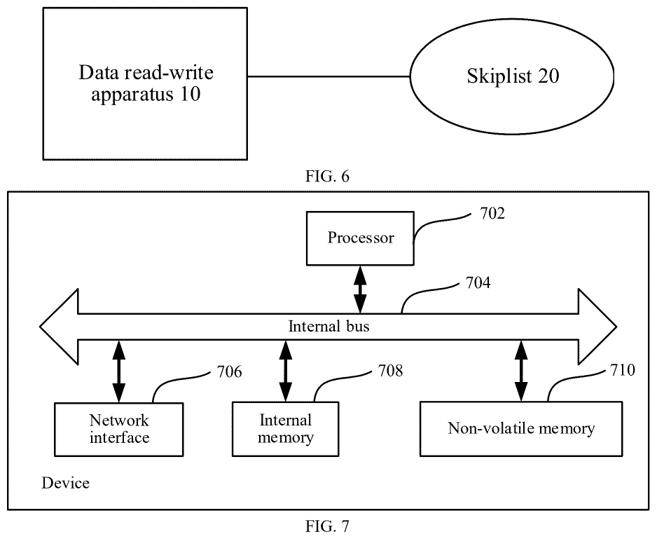

In some embodiments, please refer to FIG. 6, an embodiment of this specification further provides a storage system, including a data read-write apparatus and a skiplist, the includes a plurality of index layers, a node in the skiplist is used for storing a key and a first feature value of a current node relative to a predecessor node, and the first feature value is used for recording bifurcation position information of a key of the current node and a key of the predecessor node, as well as at least some values after a bifurcation position; and the data read-write apparatus is configured to perform the method according to any one of the foregoing.

For example, the data read-write apparatus includes a target key obtaining module, a comparison module, and a read-write module.

The target key obtaining module is configured to obtain a target key of an element to be read and written.

The comparison module is configured to determine, if the target key is different from a key of a first node of the skiplist, that a next node to which the first node points at a highest index layer is a node to be compared, and cyclically perform the following process until a preset condition is satisfied: comparing a second feature value of the target key with a first feature value of the node to be compared, where the second feature value is used for recording the bifurcation position of the target key relative to the key of the predecessor node of the node to be compared, as well as at least some values of the target key after the bifurcation position; determining, if the second feature value of the target key is different from the first feature value of the node to be compared, a node to be compared in a next cyclic process based on a magnitude relationship indicated by a comparison result.

The read-write module is configured to perform, if the preset condition is satisfied, a read-write operation on the element to be read and written based on a node to be compared in the last cyclic process.

For implementation processes of functions and effects of modules in the foregoing apparatus, specifically refer to implementation processes of corresponding steps in the foregoing method, and details are not described herein again.

In some embodiments, FIG. 7 is a schematic structural diagram of a device provided by an exemplary embodiment of the present disclosure. Please refer to FIG. 7, from a perspective of hardware, the device includes a processor 702, an internal bus 704, a network interface 706, an internal memory 708, and a non-volatile memory 710, and certainly may further include other hardware required for services. One or more embodiments of this specification may be implemented based on software. For example, the processor 702 reads a corresponding computer program from the non-volatile memory 710 into the internal memory 708 and then runs the computer program. Certainly, in addition to a software implementation, one or more embodiments of this specification do not exclude another implementation, such as a logic device or a combination of software and hardware. In other words, an execution entity of the following processing procedure is not limited to logic units, and may alternatively be hardware or a logic device.

The data read-write apparatus shown in FIG. 6 may be used in the device shown in FIG. 7, to implement the technical solutions of this specification.

In some embodiments, an embodiment of this specification further provides an electronic device, including: a processor; and a memory configured to store processor-executable instructions, where the processor is configured to run the executable instructions to implement the method according to any one of the foregoing.

In some embodiments, an embodiment of this specification further provides a computer-readable storage medium, storing computer instructions thereon, the computer instructions, when executed by a processor, implementing steps of the method according to any one of the foregoing.

In some embodiments, the electronic device integrates a computer program product. When executing the computer program product, the electronic device implements the data read-write method provided in the embodiments of this specification.

It should be noted that, user information (including but not limited to user equipment information, user personal information, and the like) and data (including but not limited to data for analysis, stored data, displayed data, and the like) involved in this specification all are information and data authorized by users or fully authorized by each party, and collection, use, and processing of related data need to comply with relevant laws, regulations, and standards of relevant countries and regions, and corresponding operation portals are provided for the users to choose to authorize or refuse.

The system, apparatus, module, or unit described in the foregoing embodiments may be specifically implemented by a computer chip or an entity, or implemented by a product having a specific function. A typical implementation device is a computer. A specific form of the computer may be a personal computer, a laptop computer, a cellular phone, a camera phone, a smart phone, a personal digital assistant, a media player, a navigation device, an email transceiver device, a game console, a tablet computer, a wearable device, or a combination of any of several of these devices.

In a typical configuration, the computer includes one or more processors (CPUs), an input/output interface, a network interface, and an internal memory.

The internal memory may include forms such as a volatile memory, a random access memory (RAM) and/or a non-volatile memory in computer-readable media, for example, a read-only memory (ROM) or a flash RAM. The internal memory is an example of the computer-readable media.

The computer-readable medium includes a persistent medium and a non-persistent medium, a removable medium and a non-removable medium, which may implement storage of information by using any method or technology. The information may be computer-readable instructions, a data structure, a program module, or other data. Examples of computer storage media include, but are not limited to, a phase change memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic disk memory, a quantum memory, a storage medium based on graphene or another magnetic storage device or any other non-transmission media that may be configured to store information that a computing device can access. As defined herein, the computer-readable media do not include transitory computer-readable media (transitory media), for example, modulated data signals and carriers.

It should be further noted that, terms “include” “comprise” or any variation thereof are intended to cover a non-exclusive inclusion. Therefore, a process, a method, a commodity, or a device that includes a series of elements not only includes those elements, but also includes other elements which are not clearly listed, or further includes inherent elements of the process, the method, the commodity, or the device. Without more limitations, elements defined by a phrase “including a/an . . . ” does not exclude that there are still other same elements in the process, the method, the commodity, or the device which includes the elements.

Specific embodiments of this specification are described above. Other embodiments are within the scope of the appended claims. In some cases, actions or steps recorded in the claims may be performed in an order different from that in the embodiments and still achieve an expected result. In addition, processes described in the accompanying drawings do not necessarily require a shown specific order or sequential order to achieve the expected result. In some implementations, multitasking processing and parallel processing may also be possible or beneficial.

Terms used in one or more embodiments of this specification are merely for describing specific embodiments but are not intended to limit one or more embodiments of this specification. Singular forms “a/an”, “the foregoing”, and “this” used in the one or more embodiments of this specification and the appended claims are also intended to include plural forms, unless the context clearly indicates otherwise. It should be further understood that, the term “and/or” used in this specification refers to and includes any or all possible combinations of one or more of associated listed items.

It should be understood that, although terms such as first, second, and third may be used to describe various information in one or more embodiments of this specification, these information should not be limited to the terms. These terms are merely used to distinguish information of the same type from each other. For example, without departing from the scope of one or more embodiments of this specification, first information may also be referred to as second information, and similarly, second information may also be referred to as first information. Depending on the context, for example, the word “if” used herein may be interpreted as “during” or “when” or “in response to determining”.

The foregoing descriptions are merely exemplary embodiments of one or more embodiments of this specification, but are not intended to limit the one or more embodiments of this specification. Any modification, equivalent replacement, or improvement made without departing from the spirit and principle of the one or more embodiments of this specification is to fall within the protection scope of the one or more embodiments of this specification.

1. A skiplist-based data read-write method, wherein the skiplist comprises a plurality of index layers, a node in the skiplist is used for storing a key and a first feature value, and the first feature value is used for recording a bifurcation position of a key of a current node relative to a key of a predecessor node, as well as at least some values of the key of the current node after the bifurcation position; and the method comprises:
obtaining a target key of an element to be read and written;
determining, if the target key is different from a key of a first node of the skiplist, that a next node to which the first node points at a highest index layer is a node to be compared, and cyclically performing the following process until a preset condition is satisfied:
comparing a second feature value of the target key with a first feature value of the node to be compared, wherein the second feature value is used for recording a bifurcation position of the target key relative to a key of a predecessor node of the node to be compared, as well as at least some values of the target key after the bifurcation position; and
determining, if the second feature value of the target key is different from the first feature value of the node to be compared, a node to be compared in a next cyclic process based on a magnitude relationship indicated by a comparison result; and
performing, if the preset condition is satisfied, a read-write operation on the element to be read and written based on a node to be compared in the last cyclic process.

2. The method according to claim 1, wherein the element to be read and written comprises an element to be read and an element to be written;
if the element to be read and written is the element to be read, the preset condition comprises: the target key is the same as a key of the node to be compared;
if the element to be read and written is the element to be written, the preset condition comprises: the target key is the same as the key of the node to be compared or a next node to be compared does not exist.

3. The method according to claim 1, wherein the determining a node to be compared in a next cyclic process based on a magnitude relationship indicated by a comparison result comprises:
if nodes in the skiplist are sorted by key in ascending order, determining, if the comparison result indicates that the target key is less than a key of the node to be compared, a next node to which the predecessor node of the node to be compared points at a next index layer as the node to be compared in the next cyclic process; determining, if the comparison result indicates that the target key is greater than the key of the node to be compared, a next node to which the node to be compared points at a current index layer as the node to be compared in the next cyclic process;
if nodes in the skiplist are sorted by key in descending order, determining, if the comparison result indicates that the target key is greater than the key of the node to be compared, a next node to which the predecessor node of the node to be compared points at a next index layer as the node to be compared in the next cyclic process; determining, if the comparison result indicates that the target key is less than the key of the node to be compared, a next node to which the node to be compared points at a current index layer as the node to be compared in the next cyclic process.

4. The method according to claim 1, wherein a data type of a key stored by any node in the skiplist is a character string type;
a first feature value of any node comprises: a first length of a common prefix between a key of the node and a key of a predecessor node, and at least some characters of the key of the node after the common prefix; and
the second feature value of the target key comprises: a second length of a common prefix between the target key and the key of the predecessor node of the node to be compared, and at least some characters of the target key after the common prefix.

5. The method according to claim 4, wherein
the method further comprises:
generating, if the target key is different from the key of the first node of the skiplist, a second feature value of the target key relative to the first node; and
if the nodes in the skiplist are sorted by key in ascending order, the determining, if the second feature value of the target key is different from the first feature value of the node to be compared, a node to be compared in a next cyclic process based on a magnitude relationship indicated by a comparison result comprises:
determining, if the second length being greater than the first length indicates that the target key is less than the key of the node to be compared, the next node to which the predecessor node of the node to be compared points at the next index layer as the node to be compared in the next cyclic process;
generating, if the second length being less than the first length indicates that the target key is greater than the key of the node to be compared, a second feature value of the target key relative to the node to be compared, and determining the next node to which the node to be compared points at the current index layer as the node to be compared in the next cyclic process;
determining, if the second length being equal to the first length and characters in the second feature value being less than characters in the first feature value indicate that the target key is less than the key of the node to be compared, the next node to which the predecessor node of the node to be compared points at the next index layer as the node to be compared in the next cyclic process;
generating, if the second length being equal to the first length and characters in the second feature value being greater than characters in the first feature value indicate that the target key is greater than the key of the node to be compared, a second feature value of the target key relative to the node to be compared, and determining the next node to which the node to be compared points at the current index layer as the node to be compared in the next cyclic process.

6. The method according to claim 5, wherein in a case that the characters in the first feature value and the characters in the second feature value are not all remaining characters after the common prefix, the method further comprises:
comparing remaining characters of the target key after the common prefix with remaining characters of the node to be compared after the common prefix if the second feature value is the same as the first feature value,
if the remaining characters of the target key after the common prefix are greater than the remaining characters of the node to be compared after the common prefix, generating the second feature value of the target key relative to the node to be compared, and determining the next node to which the node to be compared points at the current index layer as the node to be compared in the next cyclic process;
if the remaining characters of the target key after the common prefix are less than the remaining characters of the node to be compared after the common prefix, determining the next node to which the predecessor node of the node to be compared points at the next index layer as the node to be compared in the next cyclic process;
if the remaining characters of the target key after the common prefix are equal to the remaining characters of the node to be compared after the common prefix, which represents that the target key is the same as the key of the node to be compared, terminating a cycle.

7. The method according to claim 1, wherein a key stored by any node in the skiplist is a compound key, and data types of different keys in the compound key comprise a character string type or an integer type;
a first feature value of any node comprises an index of a bifurcated key between the node and a predecessor node; and if a data type of the bifurcated key is the character string type, the first feature value further comprises a first length of a common prefix between a bifurcated key of the node and a bifurcated key of the predecessor node, as well as at least some characters of the bifurcated key of the node after the common prefix; if the data type of the bifurcated key is the integer type and a quantity of bits is N, the first feature value further comprises upper M bits of an N-bit integer of the bifurcated key of the node, M≤N;
the second feature value comprises an index of a bifurcated key between the target key and the predecessor node of the node to be compared; and if the data type of the bifurcated key is the character string type, the second feature value further comprises a second length of a common prefix between a bifurcated key of the target key and a bifurcated key of the predecessor node of the node to be compared, as well as at least some characters of the bifurcated key of the target key after the common prefix; if the data type of the bifurcated key is the integer type and the quantity of bits is N, the second feature value further comprises upper M bits of an N-bit integer of the bifurcated key of the target key, wherein M≤N.

8. The method according to claim 7, wherein
the method further comprises:
generating, if the target key is different from the key of the first node of the skiplist, a second feature value of the target key relative to the first node; and
if the nodes in the skiplist are sorted by key in ascending order, the determining, if the second feature value of the target key is different from the first feature value of the node to be compared, a node to be compared in a next cyclic process based on a magnitude relationship indicated by a comparison result comprises:
determining, if an index in the second feature value being greater than an index in the first feature value indicates that the target key is less than the key of the node to be compared, the next node to which the predecessor node of the node to be compared points at the next index layer as the node to be compared in the next cyclic process;
generating, if the index in the second feature value being less than the index in the first feature value indicates that the target key is greater than the key of the node to be compared, a second feature value of the target key relative to the node to be compared, and determining the next node to which the node to be compared points at the current index layer as the node to be compared in the next cyclic process;
determining, if the index in the second feature value is equal to the index in the first feature value, the node to be compared in the next cyclic process based on a magnitude relationship between the target key and the key of the node to be compared indicated by remaining content of the second feature value and remaining content of the first feature value.

9. The method according to claim 8, wherein in a case that the data type of the bifurcated key is the integer type, the determining the node to be compared in the next cyclic process based on a magnitude relationship between the target key and the key of the node to be compared indicated by remaining content of the second feature value and remaining content of the first feature value comprises:
determining, if an integer in the second feature value being less than an integer in the first feature value indicates that the target key is less than the key of the node to be compared, the next node to which the predecessor node of the node to be compared points at the next index layer as the node to be compared in the next cyclic process;
generating, if the integer in the second feature value being greater than the integer in the first feature value indicates that the target key is greater than the key of the node to be compared, the second feature value of the target key relative to the node to be compared, and determining the next node to which the node to be compared points at the current index layer as the node to be compared in the next cyclic process.

10. The method according to claim 8, wherein in a case that the data type of the bifurcated key is the character string type, the determining the node to be compared in the next cyclic process based on a magnitude relationship between the target key and the key of the node to be compared indicated by remaining content of the second feature value and remaining content of the first feature value comprises:
determining, if the second length being greater than the first length indicates that the target key is less than the key of the node to be compared, the next node to which the predecessor node of the node to be compared points at the next index layer as the node to be compared in the next cyclic process;
generating, if the second length being less than the first length indicates that the target key is greater than the key of the node to be compared, the second feature value of the target key relative to the node to be compared, and determining the next node to which the node to be compared points at the current index layer as the node to be compared in the next cyclic process;
determining, if the second length being equal to the first length and characters in the second feature value being less than characters in the first feature value indicate that the target key is less than the key of the node to be compared, the next node to which the predecessor node of the node to be compared points at the next index layer as the node to be compared in the next cyclic process;
generating, if the second length being equal to the first length and characters in the second feature value being greater than characters in the first feature value indicate that the target key is greater than the key of the node to be compared, the second feature value of the target key relative to the node to be compared, and determining the next node to which the node to be compared points at the current index layer as the node to be compared in the next cyclic process.

11. The method according to claim 1, wherein the first feature value further comprises a first identifier of the predecessor node; and the second feature value further comprises a second identifier of the predecessor node of the node to be compared;
the comparing a second feature value of the target key with a first feature value of the node to be compared comprises:
comparing, if the first identifier in the first feature value of the node to be compared is the same as the second identifier in the second feature value of the target key, other content in the second feature value of the target key with other content in the first feature value of the node to be compared; and
the method further comprises:
comparing the target key with a key of the node to be compared if the first identifier in the first feature value of the node to be compared is different from the second identifier in the second feature value of the target key.

12. A storage system, wherein the storage system comprises a data read-write apparatus and a skiplist, wherein a node in the skiplist is used for storing a key and a first feature value of a current node relative to a predecessor node, and the first feature value is used for recording bifurcation position information of a key of the current node and a key of the predecessor node, as well as at least some values after a bifurcation position; and
the data read-write apparatus is configured to:
obtain a target key of an element to be read and written;
determine, if the target key is different from a key of a first node of the skiplist, that a next node to which the first node points at a highest index layer is a node to be compared, and cyclically perform the following process until a preset condition is satisfied:
compare a second feature value of the target key with a first feature value of the node to be compared, wherein the second feature value is used for recording a bifurcation position of the target key relative to a key of a predecessor node of the node to be compared, as well as at least some values of the target key after the bifurcation position; and
determine, if the second feature value of the target key is different from the first feature value of the node to be compared, a node to be compared in a next cyclic process based on a magnitude relationship indicated by a comparison result; and
perform, if the preset condition is satisfied, a read-write operation on the element to be read and written based on a node to be compared in the last cyclic process.

13. An electronic device, wherein the electronic device comprises:
a processor; and
a memory configured to store processor-executable instructions, wherein
the processor is configured to run the executable instructions to:
obtain a target key of an element to be read and written;
determine, if the target key is different from a key of a first node of the skiplist, that a next node to which the first node points at a highest index layer is a node to be compared, and cyclically perform the following process until a preset condition is satisfied:
compare a second feature value of the target key with a first feature value of the node to be compared, wherein the second feature value is used for recording a bifurcation position of the target key relative to a key of a predecessor node of the node to be compared, as well as at least some values of the target key after the bifurcation position; and
determine, if the second feature value of the target key is different from the first feature value of the node to be compared, a node to be compared in a next cyclic process based on a magnitude relationship indicated by a comparison result; and
perform, if the preset condition is satisfied, a read-write operation on the element to be read and written based on a node to be compared in the last cyclic process.

14. A non-transitory computer-readable storage medium, storing computer instructions thereon, wherein the instructions, when executed by a processor, implement steps of the method according to claim 1.

15. The method according to claim 2, wherein a data type of a key stored by any node in the skiplist is a character string type;
a first feature value of any node comprises: a first length of a common prefix between a key of the node and a key of a predecessor node, and at least some characters of the key of the node after the common prefix; and
the second feature value of the target key comprises: a second length of a common prefix between the target key and the key of the predecessor node of the node to be compared, and at least some characters of the target key after the common prefix.

16. The method according to claim 3, wherein a data type of a key stored by any node in the skiplist is a character string type;
a first feature value of any node comprises: a first length of a common prefix between a key of the node and a key of a predecessor node, and at least some characters of the key of the node after the common prefix; and
the second feature value of the target key comprises: a second length of a common prefix between the target key and the key of the predecessor node of the node to be compared, and at least some characters of the target key after the common prefix.

17. The method according to claim 2, wherein a key stored by any node in the skiplist is a compound key, and data types of different keys in the compound key comprise a character string type or an integer type;
a first feature value of any node comprises an index of a bifurcated key between the node and a predecessor node; and if a data type of the bifurcated key is the character string type, the first feature value further comprises a first length of a common prefix between a bifurcated key of the node and a bifurcated key of the predecessor node, as well as at least some characters of the bifurcated key of the node after the common prefix; if the data type of the bifurcated key is the integer type and a quantity of bits is N, the first feature value further comprises upper M bits of an N-bit integer of the bifurcated key of the node, M≤N;
the second feature value comprises an index of a bifurcated key between the target key and the predecessor node of the node to be compared; and if the data type of the bifurcated key is the character string type, the second feature value further comprises a second length of a common prefix between a bifurcated key of the target key and a bifurcated key of the predecessor node of the node to be compared, as well as at least some characters of the bifurcated key of the target key after the common prefix; if the data type of the bifurcated key is the integer type and the quantity of bits is N, the second feature value further comprises upper M bits of an N-bit integer of the bifurcated key of the target key, wherein M≤N.

18. The method according to claim 3, wherein a key stored by any node in the skiplist is a compound key, and data types of different keys in the compound key comprise a character string type or an integer type;
a first feature value of any node comprises an index of a bifurcated key between the node and a predecessor node; and if a data type of the bifurcated key is the character string type, the first feature value further comprises a first length of a common prefix between a bifurcated key of the node and a bifurcated key of the predecessor node, as well as at least some characters of the bifurcated key of the node after the common prefix; if the data type of the bifurcated key is the integer type and a quantity of bits is N, the first feature value further comprises upper M bits of an N-bit integer of the bifurcated key of the node, M≤N;
the second feature value comprises an index of a bifurcated key between the target key and the predecessor node of the node to be compared; and if the data type of the bifurcated key is the character string type, the second feature value further comprises a second length of a common prefix between a bifurcated key of the target key and a bifurcated key of the predecessor node of the node to be compared, as well as at least some characters of the bifurcated key of the target key after the common prefix; if the data type of the bifurcated key is the integer type and the quantity of bits is N, the second feature value further comprises upper M bits of an N-bit integer of the bifurcated key of the target key, wherein M≤N.

19. The storage system according to claim 12, the data read-write apparatus is further configured to:
if nodes in the skiplist are sorted by key in ascending order, determine, if the comparison result indicates that the target key is less than a key of the node to be compared, a next node to which the predecessor node of the node to be compared points at a next index layer as the node to be compared in the next cyclic process; determine, if the comparison result indicates that the target key is greater than the key of the node to be compared, a next node to which the node to be compared points at a current index layer as the node to be compared in the next cyclic process;
if nodes in the skiplist are sorted by key in descending order, determine, if the comparison result indicates that the target key is greater than the key of the node to be compared, a next node to which the predecessor node of the node to be compared points at a next index layer as the node to be compared in the next cyclic process; determine, if the comparison result indicates that the target key is less than the key of the node to be compared, a next node to which the node to be compared points at a current index layer as the node to be compared in the next cyclic process.

20. The electronic device according to claim 13, the processor is further configured to run the executable instructions to:
if nodes in the skiplist are sorted by key in ascending order, determine, if the comparison result indicates that the target key is less than a key of the node to be compared, a next node to which the predecessor node of the node to be compared points at a next index layer as the node to be compared in the next cyclic process; determine, if the comparison result indicates that the target key is greater than the key of the node to be compared, a next node to which the node to be compared points at a current index layer as the node to be compared in the next cyclic process; if nodes in the skiplist are sorted by key in descending order, determine, if the comparison result indicates that the target key is greater than the key of the node to be compared, a next node to which the predecessor node of the node to be compared points at a next index layer as the node to be compared in the next cyclic process; determine, if the comparison result indicates that the target key is less than the key of the node to be compared, a next node to which the node to be compared points at a current index layer as the node to be compared in the next cyclic process.
